(19) United States
(12) Patent Application Publication
(10) Pub. No.: US 2026/0198694 A1
(43) Pub. Date: Jul. 16, 2026

(54) FOLDABLE VIBROACOUSTIC EXERCISE STOOLS AND RELATED METHODS

(71) Applicant: Barbara Depta, Palm Beach Gardens, FL (US)

(72) Inventor: Barbara Depta, Palm Beach Gardens, FL (US)

(21) Appl. No.: 19/446,443

(22) Filed: Jan. 12, 2026

Related U.S. Application Data
(60) Provisional application No. 63/744,799, filed on Jan. 13, 2025.

(51) Int. Cl. A47C 9/00; A47C 4/04; A61H 23/02

(52) U.S. Cl. CPC A47C 9/002; A47C 4/04; A61H 23/0236; A61H 2201/0149; A61H 2201/0161; A61H 2201/164; A61H 2201/5005; A61H 2201/5035; A61H 2201/5048; A61H 2205/04; A61H 2205/081; A61H 2205/086; A61H 2205/106; A61H 2205/12; A61H 2209/00

(57) ABSTRACT

A foldable stool with integrated vibroacoustic components is disclosed. The foldable stool includes a seat having a rigid top surface and a bottom surface. A pair of first legs and a pair of second legs are pivotably connected to one another and movable between a collapsed position and a deployed position. Tabs extend from the bottom surface, with the first legs pivotably coupled to the tabs. A first support is coupled between the first legs, wherein in the collapsed position, the tabs and the first support form a base configured to rest on a surface. A transducer is coupled to the bottom surface, and an audio source and power source are configured to generate vibrations through the transducer. The transducer is positioned to enable vibrations to be imparted on each glute of an individual sitting on the foldable stool and into the spine.

### RELATED APPLICATION

This application claims the benefit of and priority to U.S. Provisional Patent Application Number 63/744,799, filed January 13, 2025, the content of which is incorporated by reference herein in its entirety and for all purposes.

### BACKGOUND

Therapeutic devices may be used for different purposes. Some therapeutic devices include massage chairs and recliners. Such devices may be found in homes, offices, and wellness facilities.

### SUMMARY

A foldable stool with integrated vibroacoustic components is disclosed. The foldable stool is configured to deliver therapeutic vibrations to an individual. The foldable stool may be used to impart therapeutic vibrations on different body parts of the individual. For example, the individual may sit on the stool, place their legs, and/or place their feet on the stool.

The foldable stool includes a seat having a rigid surface and one or more transducers coupled to the seat. The rigid surface may reduce dampening of vibrations, enabling a greater magnitude of the vibrations to be transmitted to the individual. The transducers are positioned relative to the seat to enable vibrations to be imparted on each glute of an individual sitting on the foldable stool and into the spine.

The foldable stool includes a pair of first legs and a pair of second legs that are pivotably connected to one another and movable between a collapsed position and a deployed position. In the deployed position, the legs rest on the floor to enable an individual to sit on the seat. In the collapsed position, a base is formed that can rest on the floor, enabling the foldable stool to be used as a low platform for seated use or as a foot platform to deliver vibrations to the lower extremities.

Vibroacoustic therapy delivered through the foldable stool may use sound waves to gently pulse blood vessels and stimulate the cells lining them and improve circulation. Vibration may activate nitric oxide release from endothelial cells, which may help keep blood vessels open and deliver oxygen to tissues.

Vibration delivered through the seat and into the spine may support bone health by promoting osteoblast activity while reducing osteoclast activity. Vibration may also support intervertebral disc health by increasing the activity of genes that produce aggrecan, collagen, decorin, and versican, which may help spinal discs hold water, maintain structure, and support tissue repair.

The foldable stool may deliver vibrations at frequencies between about 20 Hz and about 100 Hz. Frequencies of about 40 Hz and about 80 Hz may be effective for inducing spinal mobility and may reduce pain and increase range of motion. Vibration may also influence the vagus nerve and parasympathetic nervous system, supporting rest, recovery, and balance. Low-frequency vibration may impact dopamine levels and brain cell activity in areas linked to mood and motivation.

The portable and foldable nature of the stool enables use in multiple settings and configurations, providing vibroacoustic therapy to the upper body when used as a seat and to the lower body when used as a foot platform.

### BRIEF DESCRIPTION OF THE DRAWINGS

FIG. 1 illustrates a front perspective view of an example foldable stool in accordance with the teachings of this disclosure.

FIG. 2 illustrates an interior view of the foldable stool of FIG. 1.

FIG. 3 illustrates a bottom perspective view of the foldable stool in a deployed position.

FIG. 4 illustrates a side perspective view of the foldable stool of FIG. 1 in a collapsed or folded configuration.

FIG. 5 illustrates a bottom perspective view of the foldable stool of FIG. 1 in a collapsed position.

FIG. 6 illustrates a side view of the foldable stool of FIG. 1 in a collapsed position.

FIG. 7 illustrates a front view of an individual seated on the foldable stool of FIG. 1.

FIG. 8 illustrates an individual lying on the floor with their lower legs resting on the foldable stool of FIG. 1 in a deployed configuration.

FIG. 9 illustrates a front view of an individual seated on a chair with their feet resting on the foldable stool of FIG. 1 in the collapsed position.

FIG. 10 illustrates a front view of an individual seated on the foldable stool of FIG. 1 in the collapsed position for floor-level seating.

FIG. 11 illustrates a front perspective view of the foldable stool of FIG. 1 in a collapsed position and another foldable stool of FIG. 1 in the deployed position.

FIG. 12 illustrates a perspective view of another foldable stool in a deployed position in accordance with the teachings of this disclosure.

FIG. 13 illustrates a perspective bottom view of the foldable stool of FIG. 12 in a collapsed position showing transducers coupled to the bottom surface.

FIG. 14 illustrates another perspective bottom view of the seat of the foldable stool of FIG. 12 showing the transducers coupled to the bottom surface.

FIG. 15 illustrates a perspective view of an example seat positioned on a chair in accordance with the teachings of this disclosure.

### DETAILED DESCRIPTION

The examples disclosed herein relate to portable and foldable vibroacoustic dynamic movement chairs for multi-sensory therapy and core activation. The chair may be an ergonomic vibroacoustic chair. The chair may be implemented by a stool and, thus, the chair may not include a chair back and may not include chair arms.

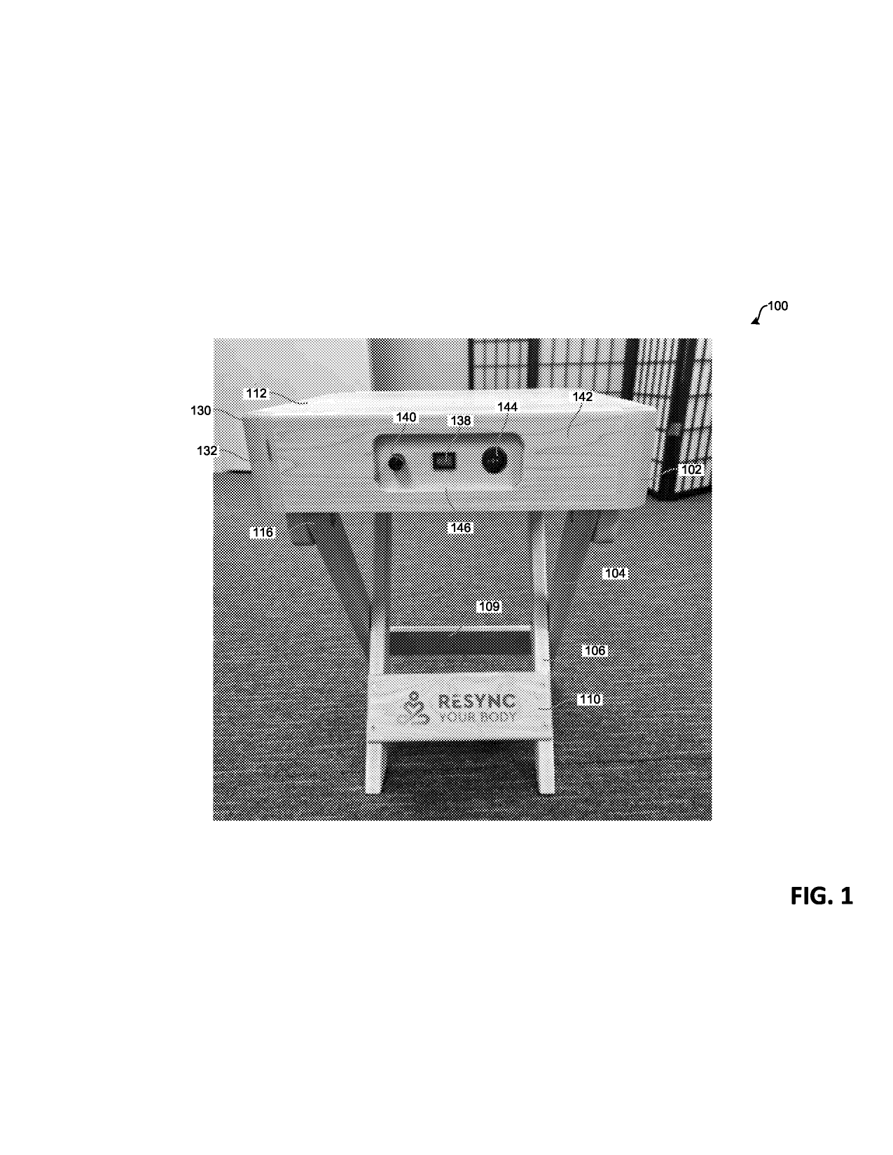

FIG. 1 illustrates a front perspective view of an example foldable stool 100 in accordance with the teachings of this disclosure. The stool 100 includes a seat 102. A pair of first legs 104 and a pair of second legs 106 are pivotably connected to one another. The first legs 104 and the second legs 106 are movable between a collapsed position and a deployed position. A support 109 is coupled between the first legs 104 and a first support 110 is coupled between the second legs 106 .The seat 102 is shown having a rigid top surface 112.

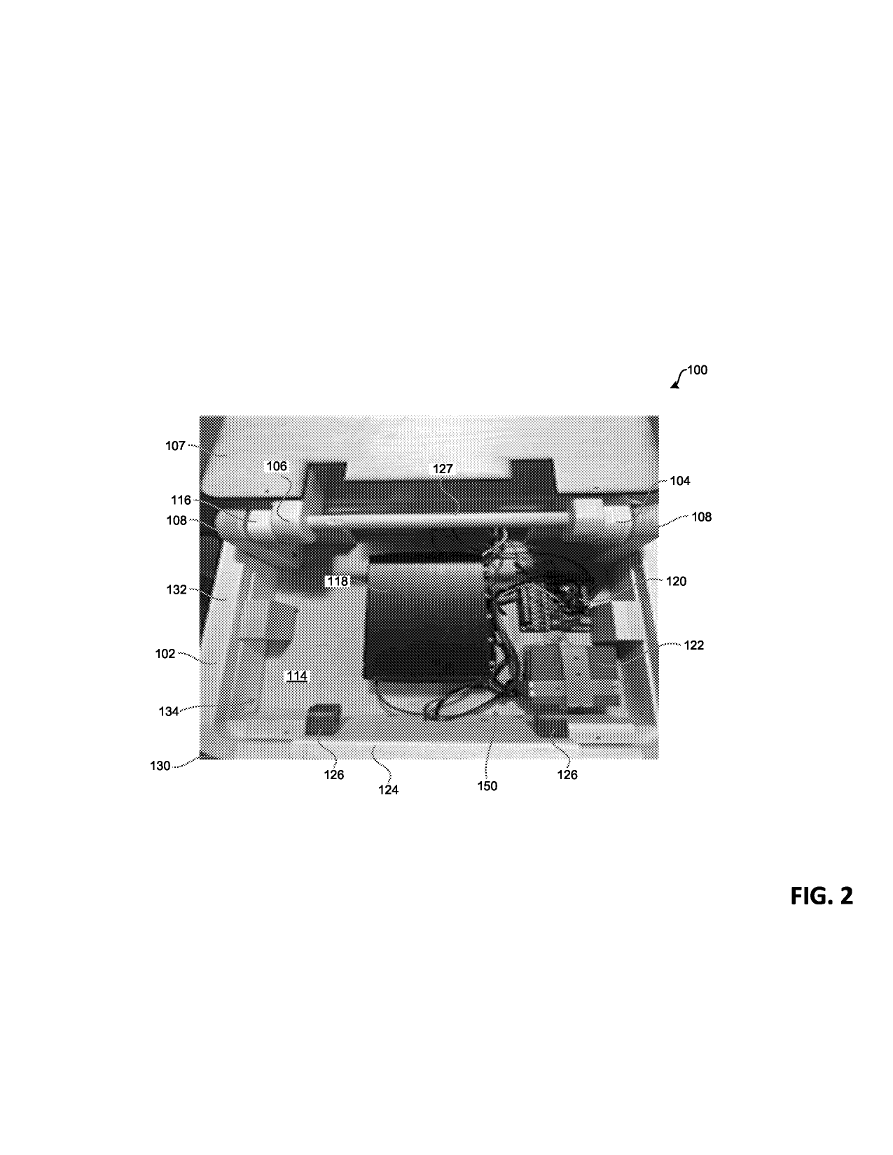

FIG. 2 illustrates an interior view of the stool 100 of FIG. 1 with a cover 107 removed. Tabs 108 extend from a bottom surface 114 of the seat 102. The tabs 108 may extend substantially perpendicularly from the bottom surface. As set forth herein, the phrase “substantially perpendicularly” means between about 0° and about 5° of perpendicular including perpendicular itself and/or accounts for manufacturing tolerances. The first legs 104 include first ends 116 pivotably coupled to the tabs 108. A transducer 118 is coupled to the bottom surface 114. An audio source 120 and a power source 122 are coupled to the seat 102. The audio source 120 is configured to generate audio signals. The power source 122 is configured to power the audio source 120 and the transducer 118. The transducer 118 is positioned relative to the seat 102 to enable vibrations to be imparted on each glute of an individual sitting on the stool 100 and into the spine, for example.

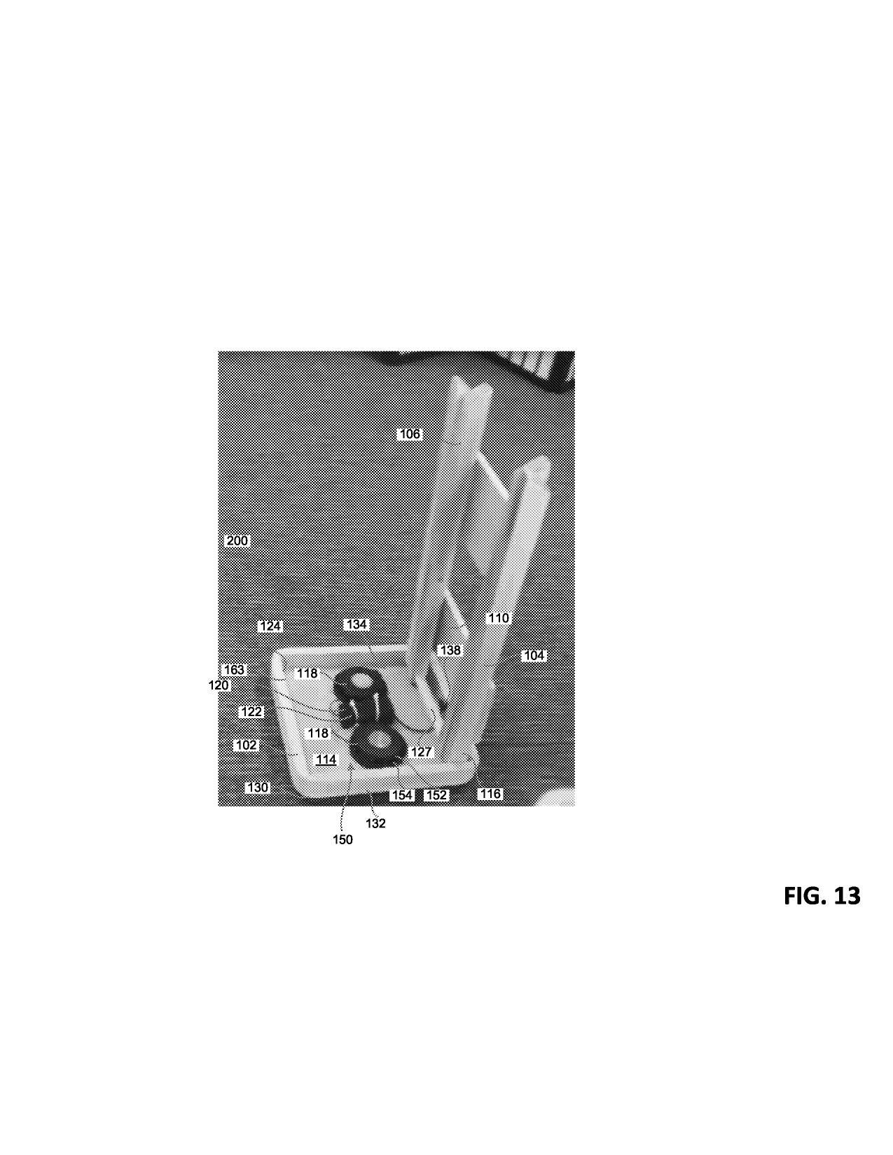

A stop 124 is shown extending from the bottom surface 114. The stop 124 may extend substantially perpendicularly from the bottom surface 114. The stop 124 is coupled to the seat 102 in the example shown and is T-shaped. The stop 124 may be differently configured and/or be formed by the seat 102 itself as shown in the seat 200 of FIG. 13. Snap-in clips 126 are coupled to the stop 124. A second support 127 is coupled between the second legs 106. The second support 127 is configured to be received by the snap-in clips 126 in the deployed position. An interaction between the second support 127 and the snap-in clips 126 secures the stool 100 in the deployed position.

The seat 102 has a perimeter 130 and side walls 132 extend downwardly from the perimeter 130 of the seat 102. The seat 102 and the side walls 132 define a cavity 134 in which the audio source 120, the power source 122, and the transducer 118 are positioned.

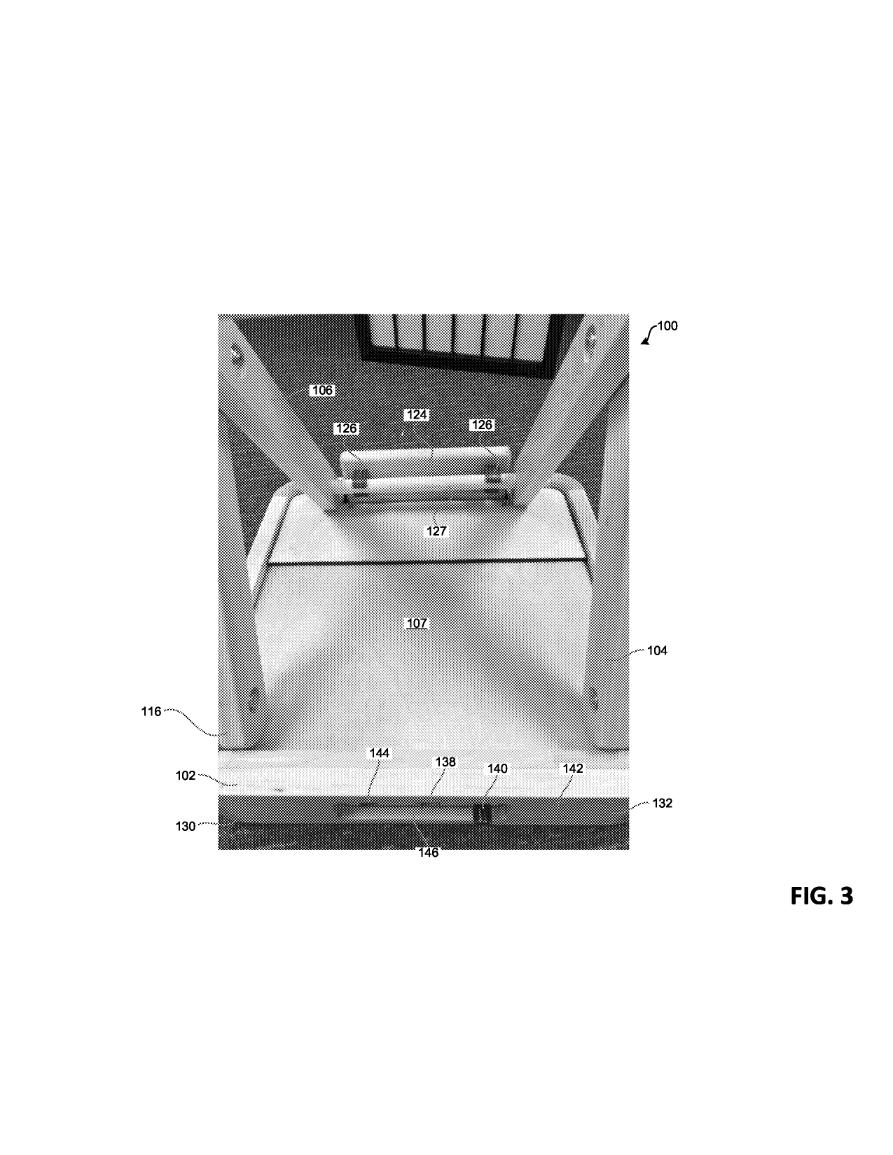

FIG. 3 illustrates a bottom perspective view of the stool 100 of FIG. 1 in a deployed position. The cover 107 is coupled to the seat 102 covering the transducer 118, the audio source 120, and the power source 122. The pair of first legs 104 and the pair of second legs 106 are shown extending outward in an X-frame configuration.

Referring back to FIG. 1, a power switch 138 and a volume dial 140 are positioned on a side 142 of the seat 102. An audio selection switch 144 is also shown positioned on the side 142 of the seat 102. The side 142 defines a recess 146 in which the power switch 138, the volume dial 140, and the audio selection switch 144 are positioned. The power switch 138 and the audio selection switch 144 are positioned within a dimensional envelope of the recess 146 in the example shown. The volume dial 140 may extend slightly outward from the recess 146. The recess 146 protects the power switch 138, the volume dial 140, and/or the audio selection switch 144 from accidental activation or damage when the stool 100 is folded into the collapsed position, for example. The recess 146 may alternatively be omitted and/or the power switch 138 and/or the volume dial 140 may extend outside the dimensional envelope of the recess 146.

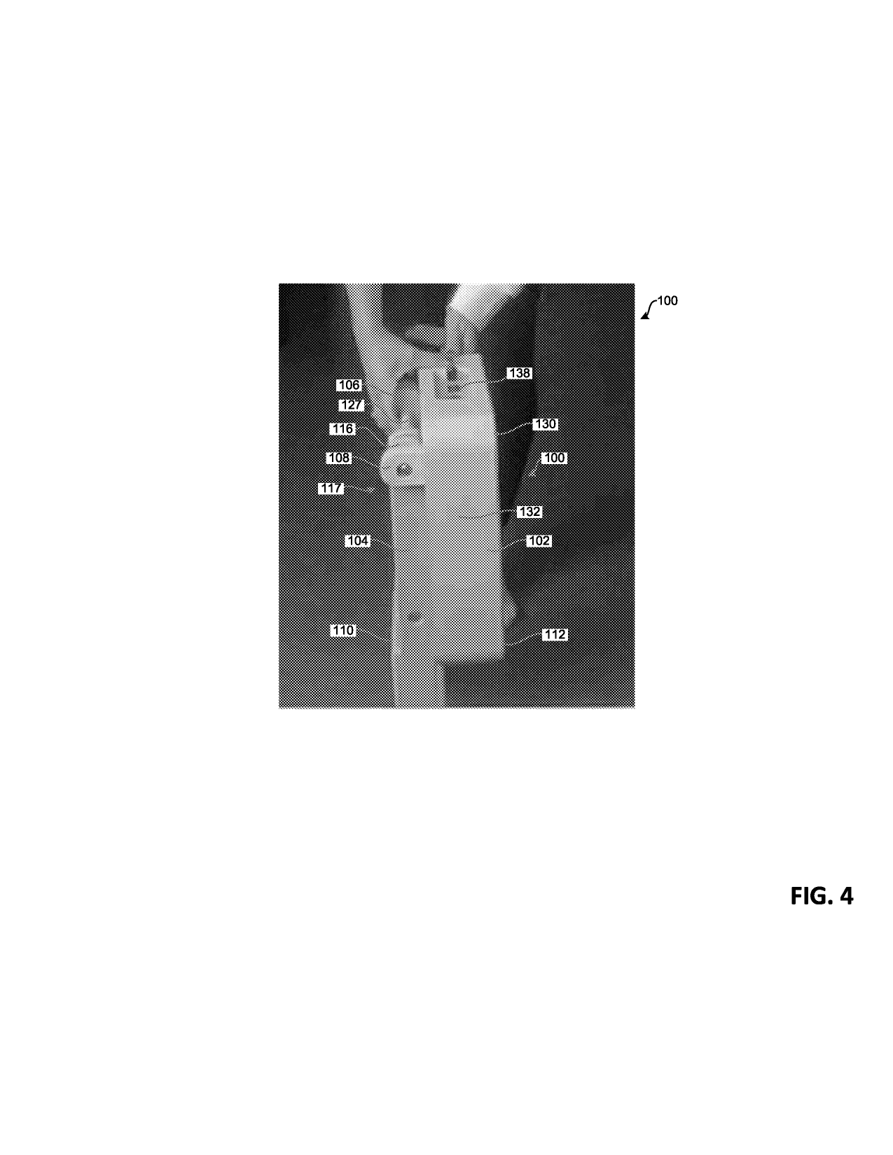

FIG. 4 illustrates a side perspective view of the stool 100 of FIG. 1 in a collapsed configuration. The first legs 104 and the second legs 106 are folded together. In the collapsed position, the tabs 108 and the first support 110 form a base 117. The base 117 is configured to be positioned on the floor to enable the stool 100 to be used as a foot rest, sat on in the collapsed position, and/or otherwise used. In the implementation shown, the first legs 104, the second legs 108, and the seat 102 are substantially parallel. As set forth herein, substantially parallel means between about 0° and about 5° degrees of parallel including parallel itself and/or accounts for manufacturing tolerances. The foldable nature of the stool 100 enables portability and ease of storage and/or enables the stool 100 to be used for a foot rest or a floor-level seat.

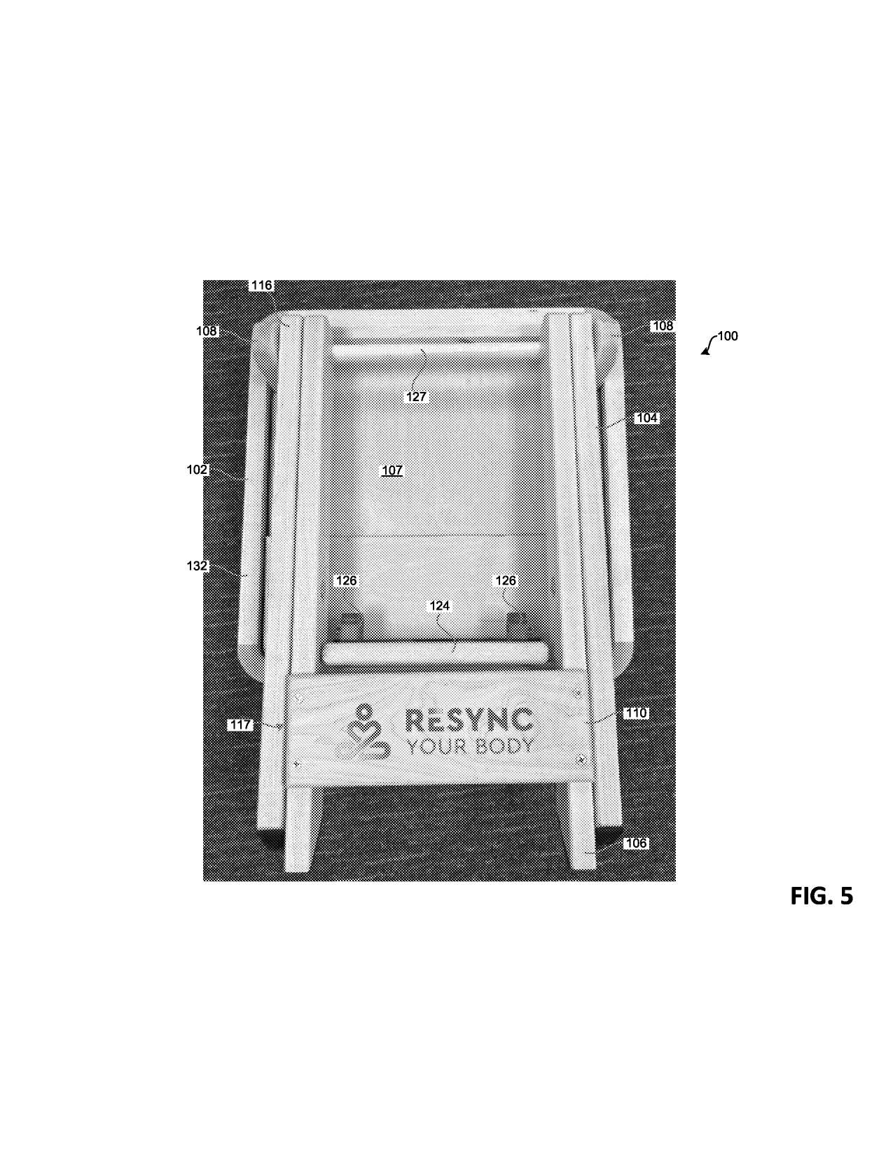

FIG. 5 illustrates a bottom perspective view of the stool 100 of FIG. 1 in a collapsed position.

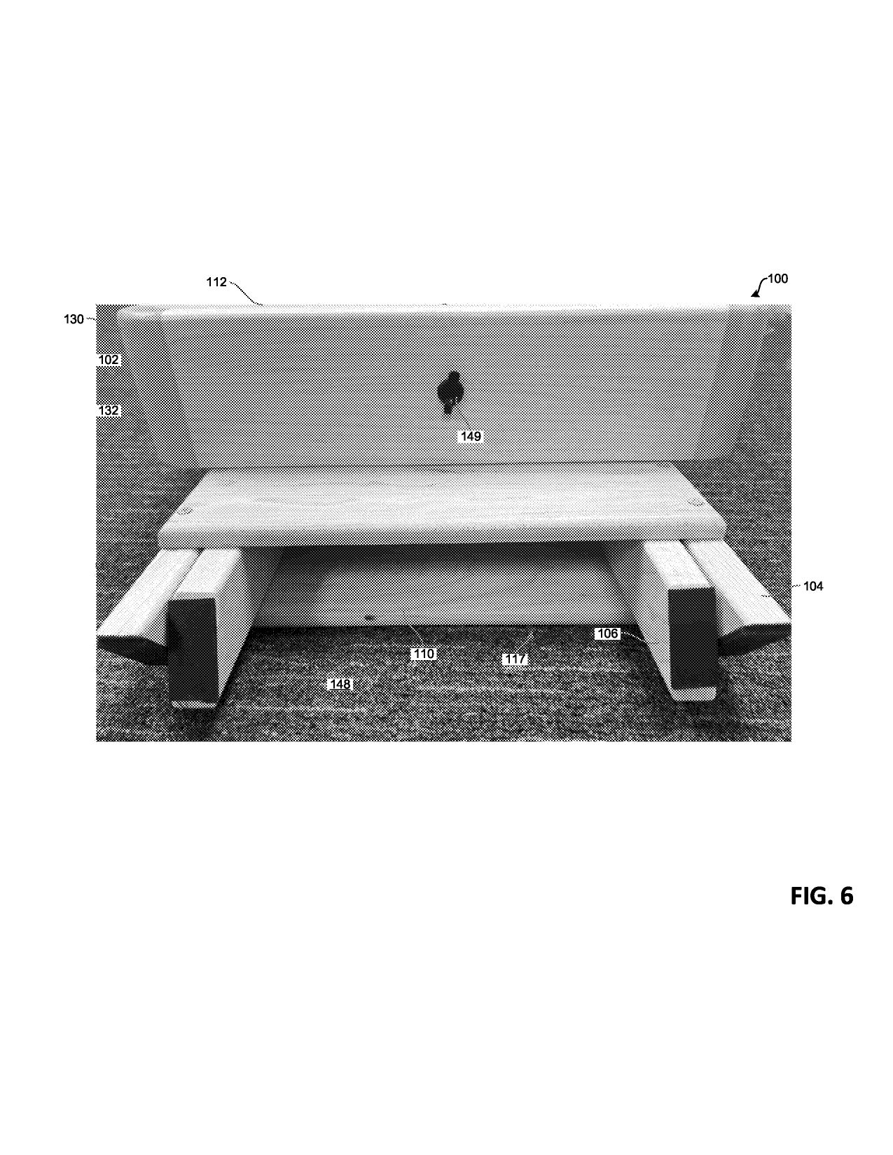

FIG. 6 illustrates a side view of the stool 100 of FIG. 1 in a collapsed position. In the example shown, the seat 102 is substantially parallel to the surface 148 on which the base 117 is positioned. In some examples, the surface is a floor. The stool 100 has a charging port 149 to enable the power source 122 to be charged, for example.

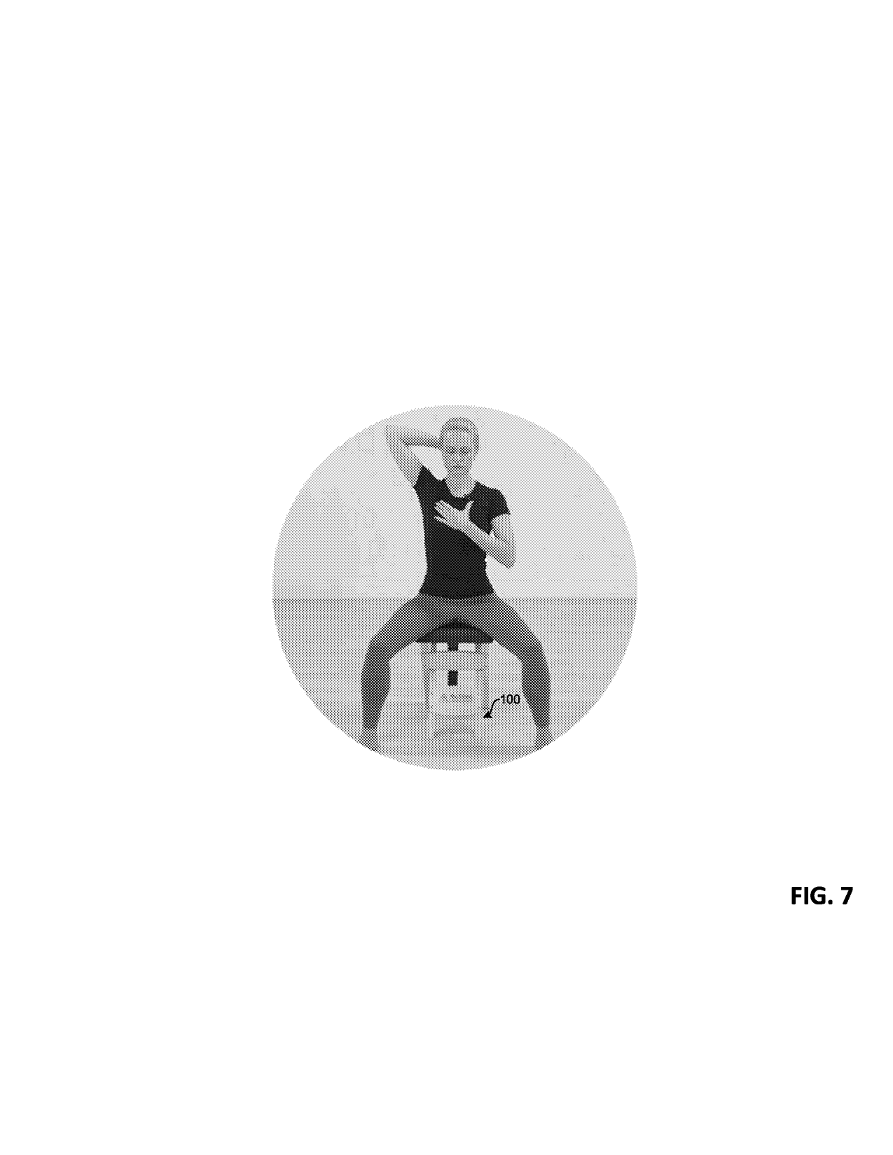

FIG. 7 illustrates a front view of an individual seated on the stool 100 of FIG. 1. The individual is seated on the seat 102 with legs spread apart in a wide stance. The individual's feet are positioned flat on the floor with the legs angled outward from the seat 102. The stool 100 may be used for training.

The stool 100 does not include a chair back and does not include chair arms in the example shown. The stool 100 without arms and/or without a back enables unrestricted multidirectional movement of the individual seated thereon. The individual may perform circular, wave-like, and undulating spine movements in all three planes of motion in some examples while maintaining active core engagement for balance and posture. The wide leg positioning encourages proper posture and enhances the transmission of vibrations through the spine when the vibroacoustic components of the foldable stool 100 are activated.

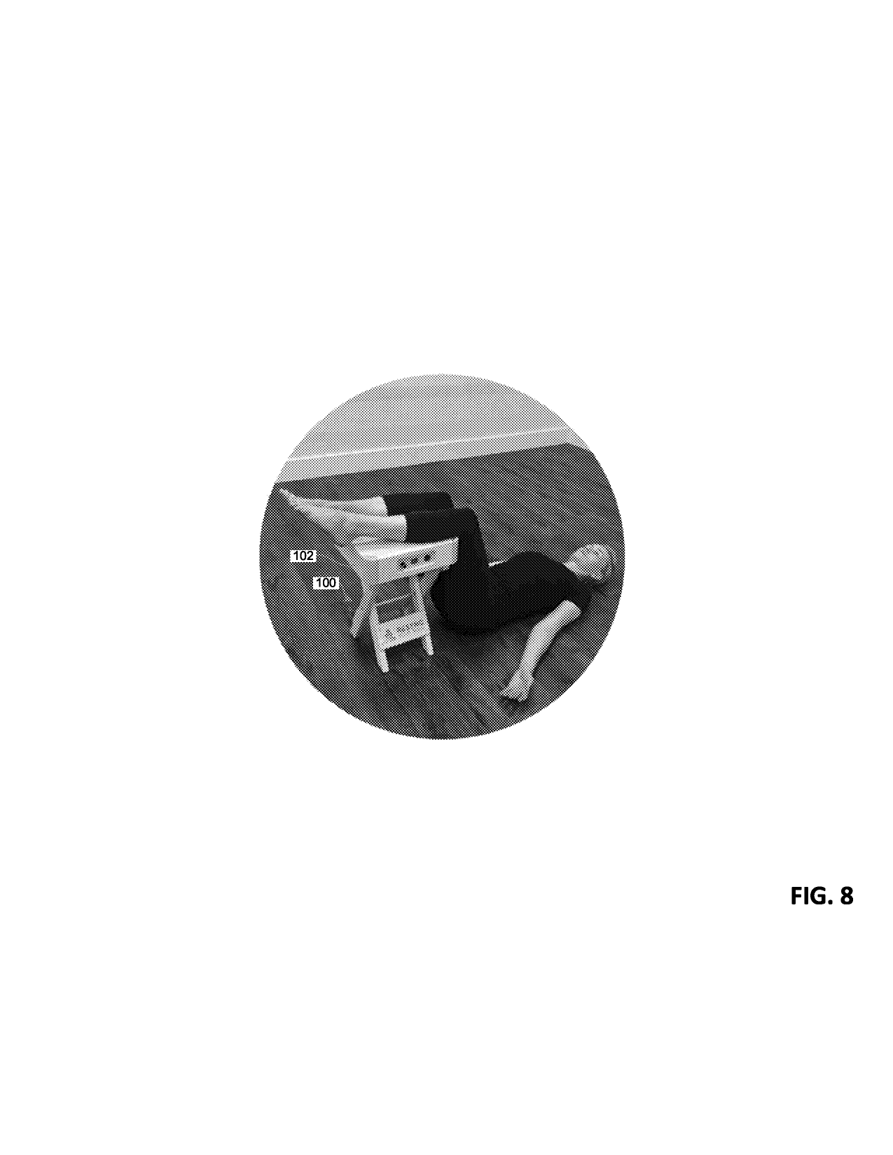

FIG. 8 illustrates an individual lying on the floor with their lower legs resting on the stool 100 of FIG. 1 in a deployed configuration. The individual is positioned with their arms relaxed at their sides. The foldable stool 100 creates a flat surface upon which the individual's calves and lower legs are elevated.

This configuration demonstrates a use case where the foldable stool 100 in the deployed position provides a leg elevation platform. The flat nature of the seat 102 enables stable support for the legs while the user remains in a relaxed, recumbent position. This arrangement allows vibrations generated by the transducer 118 to be transmitted through the calves and lower legs of the user.

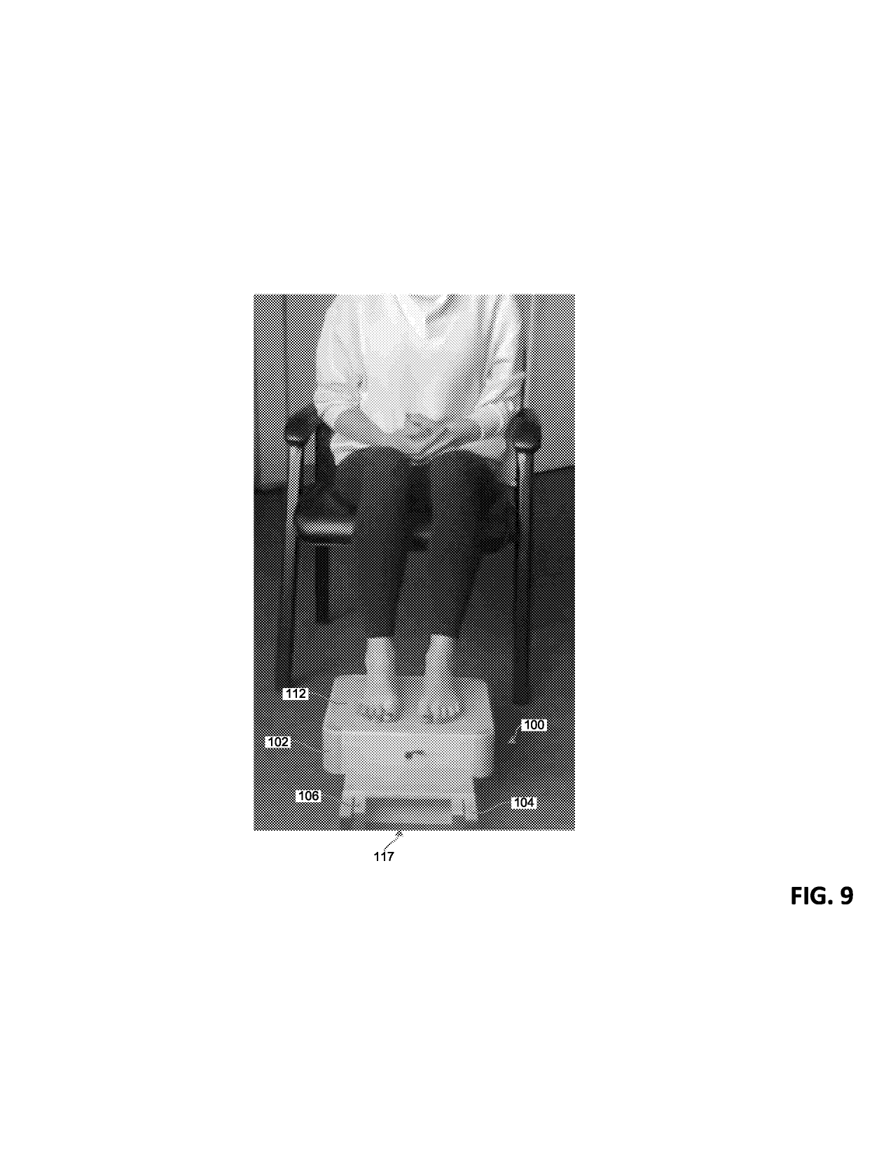

FIG. 9 illustrates a front view of an individual seated on a chair with their feet resting on the stool 100 of FIG. 1 in the collapsed position. The stool 100 is positioned on the floor in front of the chair. The individual's feet are placed flat on the top surface 112 of the seat 102 .

The dual-use configuration of the stool 100 enables the example stools 100 to provide vibroacoustic therapy to both the upper body when used as a seat in the deployed position and to the lower body when used as a foot platform in the collapsed position, for example. The foldable stool 100 may be used as a seating device and/or as a vibroacoustic platform when in the collapsed position. Using the stool 100 as a foot platform enables vibration therapy to be applied to the feet and lower extremities while the user sits in a separate chair, for example. The feet contain high densities of sensory nerve endings. Vibroacoustic stimulation applied through the feet may enhance blood circulation and vascular dynamics throughout the body. The soleus muscle in the calf functions as a peripheral heart by pumping blood back to the heart. The soleus supports circulation, oxygen delivery, brain perfusion, and glucose metabolism. Regular activation of the soleus muscle reduces post-meal glucose spikes and supports cardiovascular health. Vibroacoustic stimulation applied to the lower extremities may support the muscle pump action and improve circulatory flow from the ground up through the lower body.

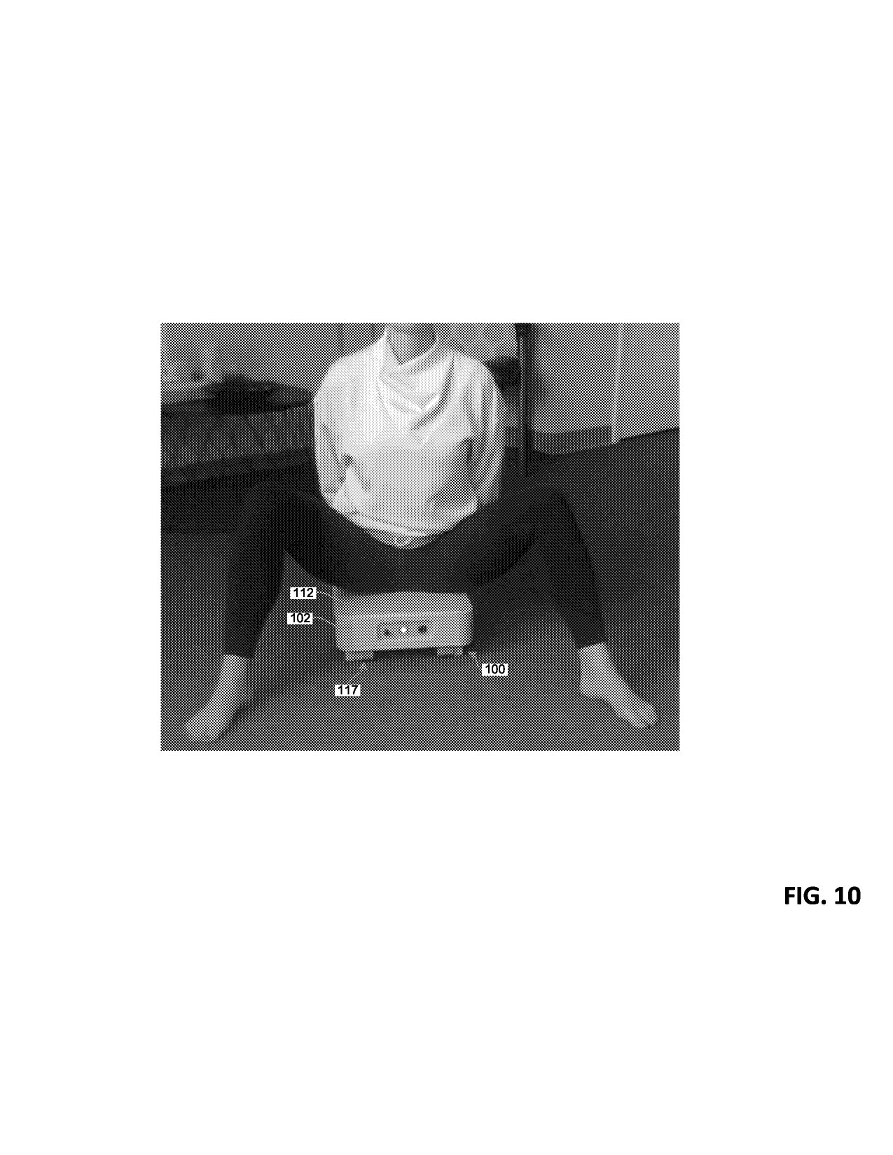

FIG. 10 illustrates a front view of an individual seated on the stool 100 of FIG. 1 in the collapsed position for floor-level seating. The individual is seated with their legs spread apart with their feet positioned flat on the floor on either side of the stool 100. An angle of the hips of the individual may change for a more yoga-like position, for example. The stool 100 is shown forming a low platform that supports the individual in a ground-level seated posture.

This configuration illustrates one of the multiple use modes of the stool 100. The collapsed position enables the individual to sit closer to the ground while receiving vibroacoustic stimulation through the seat 102. The positioning of the individual demonstrates how the foldable stool 100 accommodates a seated posture with the legs extended and feet grounded, which may facilitate vibration transmission through the body from the pelvis through the spine.

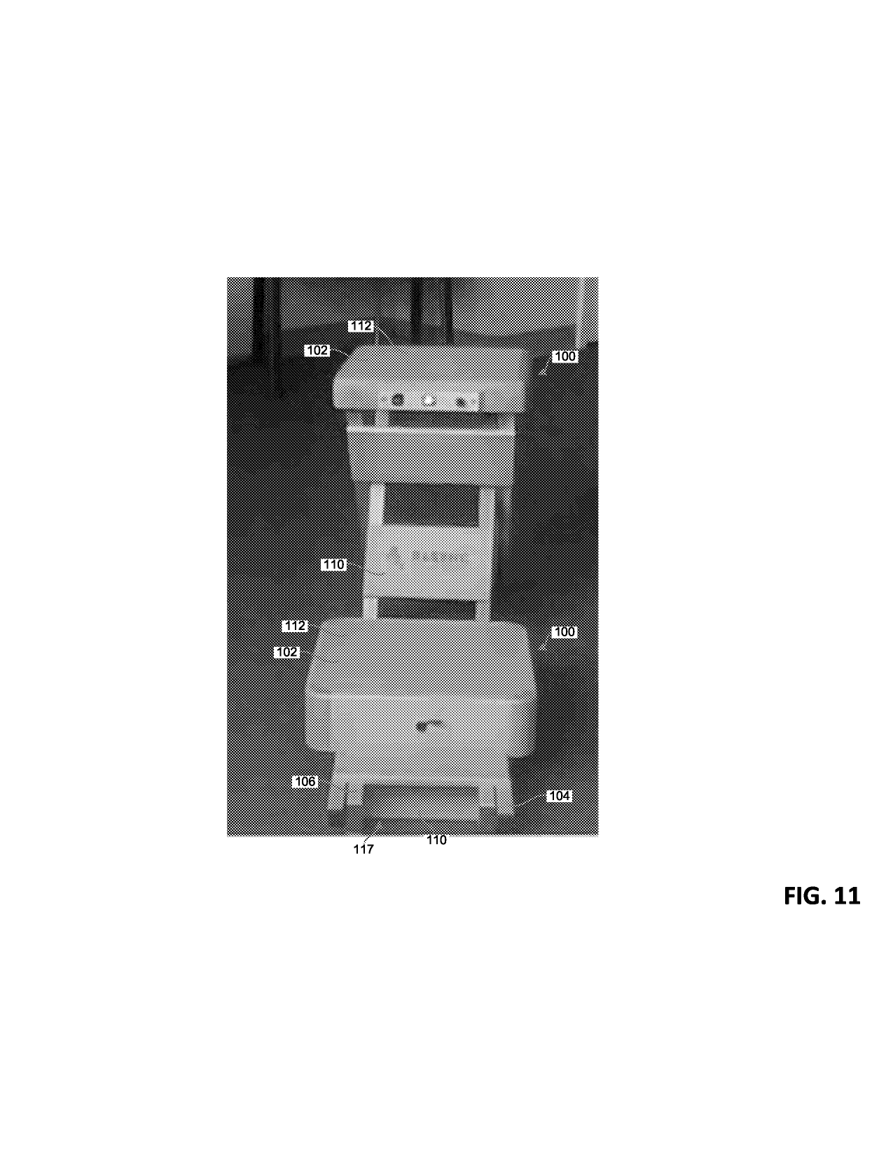

FIG. 11 illustrates a front perspective view of the stool 100 of FIG. 1 in a collapsed position and another stool 100 of FIG. 1 in the deployed position. An individual may sit on the stool 100 in the deployed position and rest their feet on the stool 100 in the collapsed position.

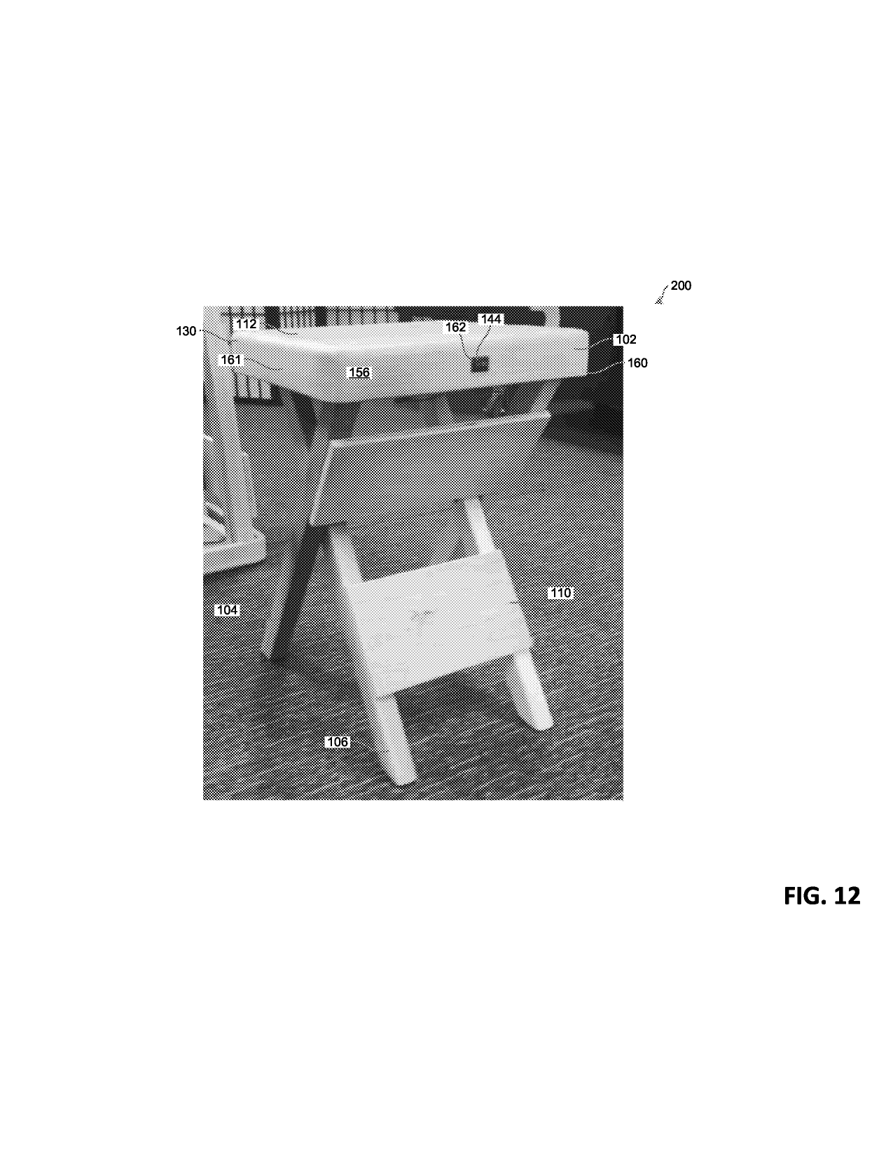

FIG. 12 illustrates a perspective view of another foldable stool 200 in a deployed position, in accordance with the teachings of this disclosure. The seat 102 has a substantially square shape with rounded edges and corners. The seat 102 is shown being made of wood 156. An interface 160 between each of the side walls 161 is curved in the example shown. One of the side walls 132 has an aperture 162. The audio selection switch 144 extends through the aperture 162. The audio selection switch 144 allows selection between a first audio track and a second audio track, for example.

FIG. 13 illustrates a bottom perspective view of the stool 200 of FIG. 12 showing transducers 118 coupled to the bottom surface 114. The first legs 104 of the stool 200 are shown pivotably coupled to the seat and the tabs 108 are omitted in the example shown. The second legs 106 and/or the second support 127 are configured to engage the stop 124 formed by an inner surface 163 of the seat 102. The audio source 120 and the power source 122 are also coupled to the stool 200. The transducers 118 are connected by wiring. The transducers 118 may be mechanically coupled directly to the bottom surface 114. In some examples, the transducers 118 are vibroacoustic transducers 152. In some examples, the transducers 118 are tactile transducers 154. Other examples may prove suitable.

Direct coupling of the transducers 118 to the rigid bottom surface 114 reduces dampening of vibrations, thereby enabling a greater magnitude of vibrations to be transmitted to a user sitting on the seat 102. The arrangement of the two transducers 118 enables vibroacoustic therapy to be delivered to both glutes simultaneously, supporting wave-like vibration transmission through the spine. In some examples, a rectangular transducer may be used instead of two circular transducers. The rectangular transducer may be more powerful than the two circular transducers combined, for example.

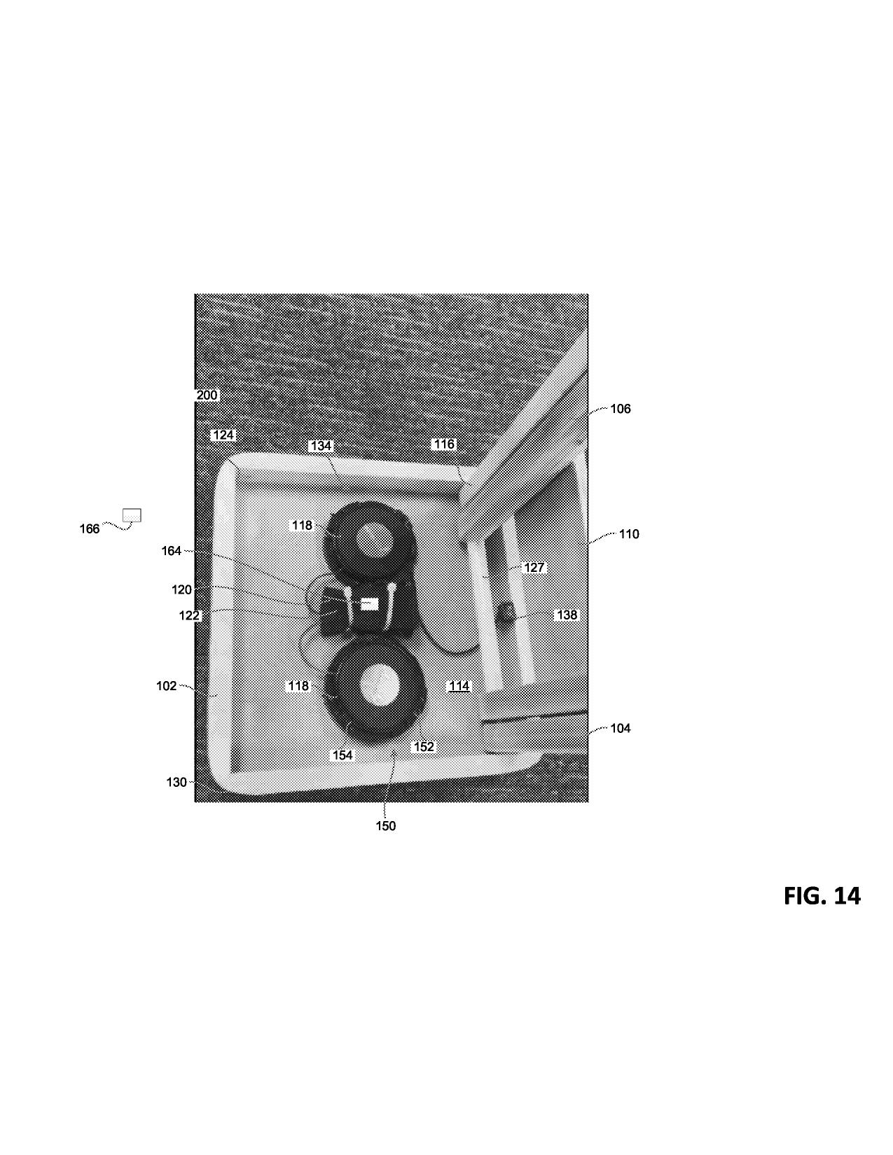

FIG. 14 illustrates another bottom isometric view of the seat 102 of the stool 200 of FIG. 12 showing the transducers 118. The transducers 118 are positioned to align with the glute regions of an individual when seated on the foldable stool 200. The transducers 118 may be differently positioned. The transducers 118 are secured to the bottom surface 114 using mounting hardware. Cable ties are used to organize and secure the wiring between the components. A memory 164 stores an audio file and is coupled to the audio source 120. The memory 164 may be removably coupled to the audio source 120. A second memory 166 stores an audio file. The memory 164 and the second memory 166 are interchangeably couplable to the audio source 120.

The removable coupling of the memory 164 enables the memory 164 to be replaced or updated with new audio files, providing flexibility in the vibroacoustic therapy programs available. The audio file on the memory 164 has data used to generate a signal that drives the transducer 118 at between about 20 Hz and about 120 Hz. In some examples, the audio file on the memory 164 has data used to generate signals that drive the transducer 118 in a pattern between one or more of 20 Hz, 40 Hz, 60 Hz, 80 Hz, and 100 Hz. Sequences in, for example, example 40Hz-52Hz-68Hz-86Hz range may be used.

The first audio track may be configured to cause the transducer 118 to impart first vibrations on the seat 102. The second audio track may be configured to cause the transducer 118 to impart second vibrations on the seat 102. In some examples, the first audio track is configured for stress release therapy with a duration of 20 minutes. In some examples, the second audio track is configured for hydration, blood flow enhancement, and chronic pain management with a duration of 20 minutes.

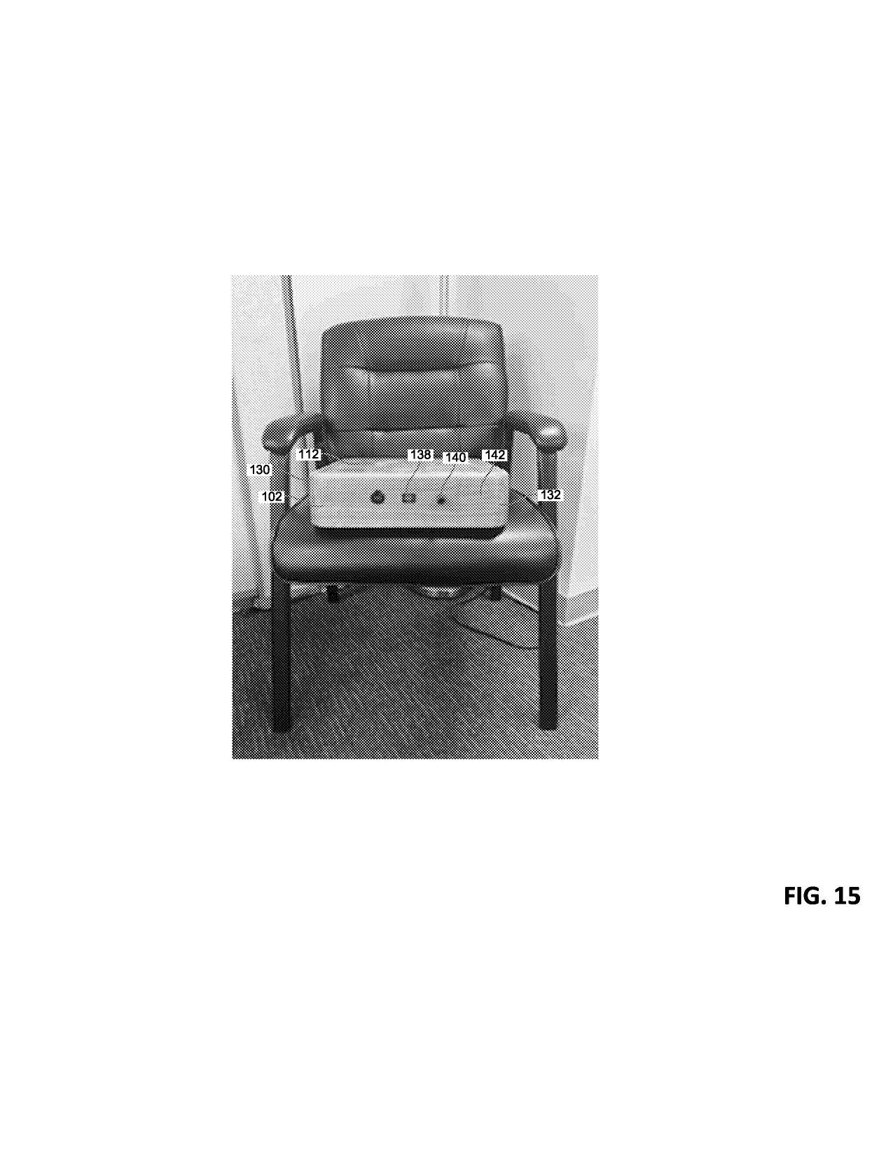

FIG. 15 illustrates a perspective view of an example seat 102 positioned on a chair in accordance with the teachings of this disclosure. The seat 102 is similar to the seat 102 of FIG. 1. The seat 102 of FIG. 15 does not include the first legs 104 or the second legs 106 and may be placed on a chair as shown or on the floor.

Vibroacoustic therapy uses sound waves to gently pulse blood vessels, stimulating the cells lining and improving circulation. Vibroacoustic therapy may help improve red blood cells' health and blood flow by activating nitric oxide, a signaling molecule that keeps blood vessels open and delivers oxygen to tissues. Nitric oxide is made by endothelial cells that line blood and lymph vessels, and when vibration stimulates these cells, they may release more nitric oxide.

The vagus nerve is one of the body's cranial nerves and a part of the parasympathetic nervous system, which helps rest, recovery, and balance. It carries signals both from the brain to the body and from the body back to the brain, influencing many functions including heart rate, digestion, immune regulation, and mood. Vibration applied to the abdominal area may influence both the vagus and splenic nerves, helping regulate inflammation and support immune health.

Vibration may support bone growth by helping stem cells turn into osteoblasts, the cells that build bone, and at the same time may slow the formation of osteoclasts, the cells that break down bone. This may create a more balanced bone environment where more bone is formed than is lost. Vibration at 40-120 Hz may increase levels of ALP, Col I, Runx2, Osx, and OCN, which are key bone-building markers.

Vibration between 0 and 200 Hz may cause spinal disc cells to produce more of the building blocks that keep discs strong and healthy. For example, vibration may increase the activity of genes that make aggrecan, which helps spinal discs hold water and stay cushioned, collagen types I and II which give the discs structure and strength, and decorin and versican which support tissue repair and organization within the disc. This gentle vibroacoustic therapy may help reduce harmful effects, support disc health, maintain hydration, and potentially reduce pain as discs degenerate.

Frequencies of 40 Hz and 80 Hz may be effective for inducing spinal mobility. The thoracic spine may be more mobile than the lumbar spine, and vibrations at 40 Hz and 80 Hz may be effective for improving movement and flexibility. Low-frequency vibrations delivered to the spine may provide improvements in pain and range of motion. Focal vibration stimulation applied to the cervical spine may translate to postural improvements of spinal alignment. The correction of spinal posture using vibration may be a mechanism behind pain relief.

A frequency of about 40 Hz may be a powerful frequency for entering a state of tranquility and may balance blood circulation. A frequency of about 40 Hz may support alkaline phosphatase activity, which is a key marker for bone mineralization. A frequency of about 40 Hz may also have potential effects on brain health. A frequency of about 52 Hz may reduce lower back pain. A frequency of about 50 Hz may ease breathing, may increase muscle strength, and may improve circulation. Vibration at about 50 Hz may enhance PGC-1α expression in the soleus, gastrocnemius, and liver, which is associated with increased muscle strength. A frequency of about 68 Hz may be associated with stress reduction, with a particular focus on the upper body regions including the upper back, shoulders, and neck. A frequency of about 80 Hz may reduce pain and stress. A frequency of about 86 Hz may reduce migraines and may increase dopamine levels.

Vibroacoustic therapy may impact dopamine levels. When vibrating specific parts of the body, the activity of brain cells involved in mood and motivation may depend on where and how the vibration is applied. Low-frequency vibration on the neck may increase dopamine and change brain cell activity in areas linked to motivation.

Within the brain, vibroacoustic therapy may enhance cerebrospinal fluid flow and accelerate the removal of metabolic waste. Some studies have shown potential neural effects, especially with prolonged exposure to a single frequency such as about 40 Hz.

The fascia system plays a role in hydration and is densely packed with nerve endings, making it one of the sensory organs affected by sound. Fascia plays a role in proprioception, which relates to body awareness and spatial positioning. Sound waves activate different sensory receptors located throughout the fascia system, supporting hyaluronic acid which attracts water molecules into the space between different fascia layers and muscles, thereby supporting mobility. Sound may hydrate tissue faster than mechanical stretching because it creates a more complete and longer-lasting molecular change.

Low-frequency vibrations between about 0 and about 200 Hz may activate the muscle stretch reflex many times per second, creating thousands of small muscle contractions in just minutes. When vibration is applied to the muscles, it triggers a chain reaction in the nervous system. Vibratory stimulation of muscle cells may decrease the expression of genes that prevent atrophy, specifically myostatin and atrogin-1.

Feet have one of the highest densities of sensory nerve endings in the body, continuously feeding the brain information about balance, pressure, and safety. When the feet are placed on a low-vibroacoustic surface, we apply sound through the feet's portals, utilizing the meridian pathways. Sound-based vibration can support vascular dynamics by enhancing the muscle pump action and microcirculatory flow, while also calming the nervous system via parasympathetic signaling.

Research shows that releasing or stimulating the plantar tissues can reduce tension not only locally, but along this entire fascial line, improving elasticity, posture, and movement efficiency.

With age, dehydration, and stiffness within fascial tissues reduce their spring-like properties; gentle mechanical vibration applied through the feet may help stimulate mechanoreceptors, encourage fluid exchange, and restore tissue “bounce.”

From an Eastern medicine perspective, multiple meridians originate or terminate at the feet—including the Kidney, Liver, Spleen, Stomach, Gallbladder, and Bladder channels—making the feet a convergence point for whole-body regulation.

While meridians are not anatomically defined in Western medicine, emerging research on mechanotransduction and connective tissue signaling suggests that vibratory input through the feet may influence global neuromyofascial communication.

The feet act as structural supports, and as dynamic regulators, where vibration, sensation, and circulation intersect to help realign the body, release stress, and rehydrate connective tissues from the ground upExamples of Combinations:

Example 1. An apparatus, comprising: a foldable stool, comprising: a seat having a rigid top surface and a bottom surface; a pair of first legs and a pair of second legs pivotably connected to one another, the first legs and the second legs movable between a collapsed position and a deployed position; tabs extending from the bottom surface, the first legs comprise first ends pivotably coupled to the tabs, a first support coupled between the second legs, wherein in the collapsed position, the tabs and the first support are configured to form a base; a transducer coupled to the bottom surface; an audio source configured to generate audio signals; and a power source, wherein the audio source, the power source, and the transducer are coupled and are configured to generate vibrations, and wherein the transducer is positioned relative to the seat to enable the vibrations to be imparted on each glute of an individual sitting on the foldable stool and into a spine, wherein the base is configured to rest on a surface when the first legs and the second legs are in the collapsed position to enable an individual to sit on the seat, wherein the first legs and the second legs are configured to rest on a surface when the first legs and the second legs are in the deployed position to enable the individual to sit on the seat.

Example 2. The apparatus of Example 1, wherein when the base is positioned on the surface in the collapsed position, the seat is substantially parallel to the surface.

Example 3. The apparatus of Example 2, wherein the surface comprises a floor.

Example 4. The apparatus of Example 1, further comprising a stop extending from the bottom surface, snap-in clips coupled to the stop, a second support coupled between the second legs, wherein the second support is configured to be received by the snap-in clips in the deployed position.

Example 5. The apparatus of Example 1, wherein the seat comprises a perimeter, further comprising side walls that extend downwardly from the perimeter of the seat.

Example 6. The apparatus of Example 5, wherein the seat and the side walls define a cavity in which the audio source, the power source, and the transducer are positioned.

Example 7. The apparatus of Example 6, further comprising a cover coupled to the seat covering the transducer, the audio source, and the power source.

Example 8. The apparatus of Example 1, further comprising a power switch and a volume dial positioned on a side of the seat.

Example 9. The apparatus of Example 8, further comprising an audio selection switch on the side of the seat.

Example 10. The apparatus of Example 9, wherein the audio selection switch enables selection between a first audio track and a second audio track.

Example 11. The apparatus of Example 10, wherein the first audio track is configured to cause the transducer to impart first vibrations on the seat and the second audio track is configured to cause the transducer to impart second vibrations on the seat.

Example 12. The apparatus of Example 11, wherein the side comprises a recess in which the power switch, the volume dial, and the audio selection switch are positioned.

Example 13. The apparatus of Example 12, wherein the power switch and the audio selection switch are positioned within a dimensional envelope of the recess.

Example 14. The apparatus of Example 1, further comprising a charging port to enable the power source to be charged.

Example 15. An apparatus, comprising: a foldable stool, comprising: a seat having a rigid bottom surface; a transducer coupled to the bottom surface; an audio source configured to generate audio signals; and a power source, wherein the audio source, the power source, and the transducer are coupled and are configured to generate vibrations, and wherein the transducer is positioned relative to the seat to enable the vibrations to be imparted on each glute of an individual sitting on the foldable stool and into a spine.

Example 16. The apparatus of Example 15, further comprising a vibroacoustic assembly comprising the transducer, a second transducer, the audio source, and the power source.

Example 17. The apparatus of Example 16, wherein the transducer and the second transducer are coupled directly to the bottom surface.

Example 18. The apparatus of Example 16, wherein the transducer and the second transducer comprise vibroacoustic transducers.

Example 19. The apparatus of Example 16, wherein the transducer and the second transducer comprise tactile transducers.

Example 20. The apparatus of Example 15, wherein the seat comprises wood.

Example 21. The apparatus of Example 20, wherein the seat comprises a top surface that is not covered by a cushion.

Example 22. The apparatus of Example 15, further comprising an audio selection switch to enable selection between a first audio track and a second audio track.

Example 23. The apparatus of Example 15, wherein the seat comprises a perimeter, further comprising side walls that extend downwardly from the perimeter of the seat.

Example 24. The apparatus of Example 23, wherein the seat and the side walls define a cavity in which the audio source, the power source, and the transducer are positioned.

Example 25. The apparatus of Example 23, wherein an interface between the perimeter of the seat and each of the side walls is curved.

Example26. The apparatus of Example 23, wherein an interface between each of the side walls is curved.

Example 27. The apparatus of Example 23, further comprising a power switch to control communication between the power source, the audio source, and the transducer.

Example 28. The apparatus of Example 27, further comprising an audio selection switch, wherein one of the side walls comprises an aperture and the audio selection switch extends through the aperture.

Example 29. The apparatus of Example 15, further comprising a memory storing an audio file and coupled to the audio source.

Example 30. The apparatus of claim 29, wherein the memory is removably coupled to the audio source.

Example 31. The apparatus of Example 30, further comprising a second memory storing an audio file, wherein the memory and the second memory are interchangeably couplable to the audio source.

Example 32. The apparatus of Example 29, wherein the audio file comprises data used to generate a signal that drives the transducer at between about 20 Hz and about 120 Hz.

Example 33. The apparatus of Example 29, wherein the audio file comprises data used to generate signals that drive the transducer in a pattern between one or more of 20 Hz, 40 Hz, 60 Hz, 80 Hz, and 100 Hz.

Example 34. The apparatus of Example 15, wherein the foldable stool comprises an X-frame stool.

Example 35. An apparatus, comprising: a seat having a rigid top surface and a rigid bottom surface; a transducer coupled to the bottom surface; an audio source configured to generate audio signals; and a power source, wherein the audio source, the power source, and the transducers are coupled and are configured to generate audio waves, wherein the transducer is positioned relative to the seat to enable the audio waves to be imparted on each glute of an individual sitting on the seat and into a spine.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The following claims recite aspects of certain examples of the disclosed subject matter and are considered to be part of the above disclosure. These aspects may be combined with one another.

What is claimed is:

1. An apparatus, comprising:
a foldable stool, comprising:
a seat having a rigid top surface and a bottom surface;
a pair of first legs and a pair of second legs pivotably connected to one another, the first legs and the second legs movable between a collapsed position and a deployed position;
tabs extending from the bottom surface, the first legs comprise first ends pivotably coupled to the tabs;
a first support coupled between the second legs, wherein in the collapsed position, the tabs and the first support are configured to form a base;
a transducer coupled to the bottom surface;
an audio source configured to generate audio signals; and
a power source,
wherein the audio source, the power source, and the transducer are coupled and are configured to generate vibrations,
wherein the transducer is positioned relative to the seat to enable the vibrations to be imparted on each glute of an individual sitting on the foldable stool and into a spine,
wherein the base is configured to rest on a surface when the first legs and the second legs are in the collapsed position to enable an individual to sit on the seat,
wherein the first legs and the second legs are configured to rest on a surface when the first legs and the second legs are in the deployed position to enable the individual to sit on the seat.

2. The apparatus of claim 1, wherein when the base is positioned on the surface in the collapsed position, the seat is substantially parallel to the surface.

3. The apparatus of claim 2, wherein the surface comprises a floor.

4. The apparatus of claim 1, further comprising a stop extending from the bottom surface, snap-in clips coupled to the stop, a second support coupled between the second legs, wherein the second support is configured to be received by the snap-in clips in the deployed position.

5. The apparatus of claim 1, wherein the seat comprises a perimeter, further comprising side walls that extend downwardly from the perimeter of the seat.

6. The apparatus of claim 5, wherein the seat and the side walls define a cavity in which the audio source, the power source, and the transducer are positioned.

7. The apparatus of claim 6, further comprising a cover coupled to the seat covering the transducer, the audio source, and the power source.

8. The apparatus of claim 1, further comprising a power switch and a volume dial positioned on a side of the seat.

9. The apparatus of claim 8, further comprising an audio selection switch on the side of the seat.

10. The apparatus of claim 9, wherein the audio selection switch enables selection between a first audio track and a second audio track.

11. The apparatus of claim 10, wherein the first audio track is configured to cause the transducer to impart first vibrations on the seat and the second audio track is configured to cause the transducer to impart second vibrations on the seat.

12. The apparatus of claim 11, wherein the side comprises a recess in which the power switch, the volume dial, and the audio selection switch are positioned.

13. The apparatus of claim 12, wherein the power switch and the audio selection switch are positioned within a dimensional envelope of the recess.

14. The apparatus of claim 1, further comprising a charging port to enable the power source to be charged.

15. An apparatus, comprising:
a foldable stool, comprising:
a seat having a rigid bottom surface;
a transducer coupled to the bottom surface;
an audio source configured to generate audio signals; and
a power source,
wherein the audio source, the power source, and the transducer are coupled and are configured to generate vibrations, and
wherein the transducer is positioned relative to the seat to enable the vibrations to be imparted on each glute of an individual sitting on the foldable stool and into a spine.

16. The apparatus of claim 15, further comprising a vibroacoustic assembly comprising the transducer, a second transducer, the audio source, and the power source.

17. The apparatus of claim 16, wherein the transducer and the second transducer are coupled directly to the bottom surface.

18. The apparatus of claim 16, wherein the transducer and the second transducer comprise vibroacoustic transducers.

19. The apparatus of claim 16, wherein the transducer and the second transducer comprise tactile transducers.

20. The apparatus of claim 15, wherein the seat comprises wood.

21. The apparatus of claim 20, wherein the seat comprises a top surface that is not covered by a cushion.

22. The apparatus of claim 15, further comprising an audio selection switch to enable selection between a first audio track and a second audio track.

23. The apparatus of claim 15, wherein the seat comprises a perimeter, further comprising side walls that extend downwardly from the perimeter of the seat.

24. The apparatus of claim 23, wherein the seat and the side walls define a cavity in which the audio source, the power source, and the transducer are positioned.

25. The apparatus of claim 23, wherein an interface between the perimeter of the seat and each of the side walls is curved.

26. The apparatus of claim 23, wherein an interface between each of the side walls is curved.

27. The apparatus of claim 23, further comprising a power switch to control communication between the power source, the audio source, and the transducer.

28. The apparatus of claim 27, further comprising an audio selection switch, wherein one of the side walls comprises an aperture and the audio selection switch extends through the aperture.

29. The apparatus of claim 15, further comprising a memory storing an audio file and coupled to the audio source.

30. The apparatus of claim 29, wherein the memory is removably coupled to the audio source.

31. The apparatus of claim 30, further comprising a second memory storing an audio file, wherein the memory and the second memory are interchangeably couplable to the audio source.

32. The apparatus of claim 29, wherein the audio file comprises data used to generate a signal that drives the transducer at between about 20 Hz and about 100 Hz.

33. The apparatus of claim 29, wherein the audio file comprises data used to generate signals that drive the transducer in a pattern between one or more of 20 Hz, 40 Hz, 60 Hz, 80 Hz, and 120 Hz.

34. The apparatus of claim 15, wherein the foldable stool comprises an X-frame stool.

35. An apparatus, comprising:
a seat having a rigid top surface and a rigid bottom surface;
a transducer coupled to the bottom surface;
an audio source configured to generate audio signals; and
a power source,
wherein the audio source, the power source, and the transducers are coupled and are configured to generate audio waves,
wherein the transducer is positioned relative to the seat to enable the audio waves to be imparted on each glute of an individual sitting on the seat and into a spine.
